(19) United States
(12) Patent Application Publication
(10) Pub. No.: US 2009/0157555 A1
(43) Pub. Date: Jun. 18, 2009

(54) BILL PAYMENT SYSTEM AND METHOD

(75) Inventors: Janet Leslee Biffle, Cave Creek, AZ (US); William J. Gray, Peoria, AZ (US); Lesley Leggatt, Glendale, AZ (US); Leigh R. Malnati, Mountain Lakes, NJ (US); Chris M. Schuyler, Litchfield Park, AZ (US); Danielle Sykes, Atlantic Highlands, NJ (US); Ursula Winter, Valley Stream, NY (US)

Correspondence Address: Snell & Wilmer L.L.P. (AMEX), ONE ARIZONA CENTER, 400 E. VAN BUREN STREET, PHOENIX, AZ, 85004-2202, US

(73) Assignee: American Express Travel Related Services Company,, New York, NY (US)

(21) Appl. No.: 12/061,497

(22) Filed: Apr. 2, 2008

Related U.S. Application Data
(60) Provisional application No. 61/013,275, filed on Dec. 12, 2007.

(51) Int. Cl. G06Q 20/00; H04L 9/32; G06Q 30/00

(52) U.S. Cl. 705/67; 705/44; 705/40; 705/35; 705/34

(57) ABSTRACT

Automated authorization and processing of an interim payment is disclosed. When a merchant requests payment prior to a recurring payment process being enabled, the system handles the payment request without customer intervention. The system requests and receives a transaction coordination code for an interim payment from a financial processor. The system passes the interim payment transaction coordination code to the merchant so the merchant may obtain an authorized payment.

### RELATED APPLICATIONS

This application claims priority to, and the benefit of, U.S. Provisional Ser. No. 61/013,275 filed on Dec. 12, 2007 and entitled BILL PAYMENT SYSTEM AND METHOD, which is hereby incorporated by reference.

### FIELD OF THE INVENTION

The present invention generally relates to automating the process for obtaining authorization for a transaction, and more particularly, to processing an interim payment request when a recurring payment process is not yet established.

### BACKGROUND OF THE INVENTION

In recent years, many financial transactions have been automated to increase efficiency and reduce costs associated with financial services. In this automated environment, merchants have the ability to invoice customers electronically and financial service providers offer products that enable electronic payments. Customers often elect to receive invoices electronically, and when appropriate, arrange for recurring payments that are initiated automatically according to a schedule or upon an event. Bill paying services often act as the coordinating point for automated transactions between transaction account issuers, merchants and customers. For example, in a common situation, a transaction account holder may use a billing service to coordinate his payments. These payments may be charged to a transaction account. Upon receipt of an invoice from a merchant, the bill paying service informs the customer, the customer authorizes payment and the bill paying service requests the payment transaction from the transaction account issuer to the merchant. In another exemplary situation, recurring payments to a merchant may be automated and customer intervention in the recurring billing process reduced.

Typically, a customer establishes an account with a merchant and then sets up that merchant with the bill paying service. The bill paying service coordinates with the merchant so that the merchant interfaces with the bill paying service rather than interfacing with the customer directly. The merchant may need to change its internal systems to accommodate this situation. In that regard, a bill often becomes due before the merchant has completed the task of configuring its internal systems to enable automatic bill payment rather than direct interaction with the customer. In this situation, a payment outside of the recurring bill paying process is needed; this type of payment is often referred to as an “interim payment.” For further information regarding automatic payments and recurrent billing see, for example, Recurrent Billing Maintenance System For Use With Radio Frequency Payment Devices, Ser. No. 10/710,613, filed on Sep. 28, 2004, which is hereby incorporated by reference.

Traditional interim payment methods and systems often require customer intervention to ensure that any interim payments occur. Intervention by the customer is often required because, if an interim payment is initiated by the merchant (i.e. the customer is not involved in the interim payment), the merchant may not have access to the additional information required as part of the authorization request to charge the transaction account. Certain types of information provided by the customer as part of initializing a payment, or setting up recurring payments, are often not permitted to be stored by merchants due to, for example, legal issues, privacy policy concerns, contract requirements and/or other restrictions. For example, a transaction account identification number is usually required to initiate a charge to a transaction account. An example of a common transaction account identification number is the card identification (CID) number used in many credit or charge card transaction accounts. The merchant is typically not authorized to store the transaction account unique identification data. As such, merchants usually either need to confirm that the customer initiate such an interim payment or contact the customer to obtain the information to complete an authorization request.

Existing payment systems and methods which require customer intervention typically detract from the value and convenience of automated financial transactions. A long-felt need exists to streamline, enhance and automate payment processes. Enhancing the electronic payment capabilities provided by a transaction account issuer will benefit all entities involved in the financial transaction process, including consumers, merchants and third-party billings services.

### SUMMARY OF THE INVENTION

The present invention improves upon existing systems and methods by providing a tangible, integrated, end-to-end interim payment authorization mechanism. When a merchant requests payment prior to a recurring payment process being enabled, the system handles the payment request with minimal or no customer intervention. The system requests and receives a transaction coordination code for an interim payment from a financial processor (e.g., transaction account issuer, a credit card company, etc). The system passes certain information to coordinate and submit an interim payment to the merchant so that the merchant can submit an authorization payment request to the financial processor.

In one embodiment, an enhanced method processes payment requests from a merchant or a billing service. The process includes receiving a payment request from a merchant (e.g. via screen scraping techniques); and determining if automatic bill payment for the requesting transaction account/merchant combination is established in the merchant's billing system. If automatic bill payment is already enabled, the merchant requests payment from the financial transaction account issuer who authorizes the payment. However, if recurring bill payment is not already established, the process continues. The system determines the time elapsed between the payment request and the time that the customer authorized recurring billing. If the elapsed time is greater than the specified time, the payment request is denied, then an error or exception is generated. However, if the elapsed time is less than the specified time, the process continues and an “interim” payment is initiated. Transaction account information such as a transaction coordination code that is unique to the customer account, the interim payment, the merchant and/or some other uniquely identifying characteristic is returned by the transaction account issuer. The system receives the transaction coordination code and sends the transaction coordination code to the merchant. The merchant submits a payment request with a valid transaction coordination code to the transaction account issuer.

### BRIEF DESCRIPTION OF THE DRAWINGS

A more complete understanding of the invention may be derived by referring to the detailed description and claims when considered in connection with the Figures, wherein like reference numbers refer to similar elements throughout the Figures, and:

FIG. 1 is an overview of a representative system for authorizing an interim payment, in accordance with one embodiment of the present invention.

FIG. 2 is a representative process flow diagram for establishing a bill paying service, in accordance with one embodiment of the present invention.

FIG. 3 is a representative process flow diagram for processing payment requests by from a merchant to a bill paying service, in accordance with one embodiment of the present invention.

### DETAILED DESCRIPTION OF EXEMPLARY EMBODIMENTS

The detailed description of exemplary embodiments of the invention herein makes reference to the accompanying drawings, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

In one embodiment, the system includes a graphical user interface (GUI), a software module, logic engines, numerous databases and computer networks. While the system may contemplate upgrades or reconfigurations of existing processing systems, changes to existing databases and business information system tools are not necessarily required by the present invention.

The exemplary benefits provided by this invention include reducing risk of fraud, eliminating or reducing manual intervention, improving the data integrity of the payment system and an increase in revenue associated with improved transaction success rate. For account issuers and processors, benefits include, for example, reducing the risk of processing a fraudulent transaction by requesting customer specific information as part of an automated authorization request from a participating merchant. Furthermore, the improved processes and systems enhance customer value by providing a long-felt need to partially or completely automate recurring billing processes. Account issuers and processors also benefit from this invention due to increased likelihood of successful setup of recurring bill payment transactions, and hence a higher transaction success rate. For merchants, benefits include, for example, reducing the risk of processing a fraudulent transaction and allowing transactions to be processed when the transaction may have otherwise required additional manual or customer intervention. Customer benefits include time-savings and convenience by eliminating or reducing manual intervention, reduced fraud and reduced late payment fees that may have otherwise been charged if a merchant did not receive the appropriate payment due to the interim billing problem.

While described in the context of systems and methods that enable payment of bills, practitioners will appreciate that the present invention may be similarly used to enhance functionality, improve user satisfaction, increase speed, lower costs and reduce the risk of fraud in the context of providing authorization services and tools for anything that includes authorization and/or that would benefit from automating an authorization process. Other embodiments of such authorization automation techniques may be accomplished through a variety of computing resources and hardware infrastructures.

While the description makes reference to specific technologies, system architectures and data management techniques, practitioners will appreciate that this description is but one embodiment and that other devices and/or methods may be implemented without departing from the scope of the invention. Similarly, while the description makes frequent reference to a web client, practitioners will appreciate that other examples of bill payment service setup, operation and reporting may be accomplished by using a variety of user interfaces including handheld devices such as personal digital assistants and cellular telephones.

“Entity” may include any individual, consumer, customer, group, business, organization, government entity, transaction account issuer or processor (e.g., credit, charge, etc), merchant, consortium of merchants, customer, account holder, charitable organization, software, hardware, and/or any other entity.

An “account”, “account number” or “customer account” as used herein, may include any device, code (e.g., one or more of an authorization/access code, personal identification number (“PIN”), Internet code, other identification code, and/or the like), number, letter, symbol, digital certificate, smart chip, digital signal, analog signal, biometric or other identifier/indicia suitably configured to allow the consumer to access, interact with or communicate with the system. The account number may optionally be located on or associated with a rewards card, charge card, credit card, debit card, prepaid card, telephone card, secure hardware area or software element associated with a phone or mobile device, embossed card, smart card, magnetic stripe card, bar code card, transponder, radio frequency card or an associated account. The system may include or interface with any of the foregoing cards or devices, or a fob having a transponder and RFID reader in RF communication with the fob. Although the system may include a fob embodiment, the invention is not to be so limited. Indeed, the system may include any device having a transponder which is configured to communicate with an RFID reader via RF communication. Typical devices may include, for example, a key ring, tag, card, cell phone, wristwatch or any such form capable of being presented for interrogation. Moreover, the system, computing unit or device discussed herein may include a “pervasive computing device,” which may include a traditionally non-computerized device that is embedded with a computing unit. Examples may include watches, Internet enabled kitchen appliances, restaurant tables embedded with RF readers, wallets or purses with imbedded transponders, etc.

The account number may be distributed and stored in any form of plastic, electronic, magnetic, radio frequency, wireless, audio and/or optical device capable of transmitting or downloading data from itself to a second device. A customer account number may be, for example, a sixteen-digit credit card number, although each credit provider has its own numbering system, such as the fifteen-digit numbering system used by American Express. Each company's credit card numbers comply with that company's standardized format such that the company using a fifteen-digit format will generally use three-spaced sets of numbers, as represented by the number “0000 000000 00000”. The first five to seven digits are reserved for processing purposes and identify the issuing bank, card type, etc. In this example, the last (fifteenth) digit is used as a sum check for the fifteen digit number. The intermediary eight-to-eleven digits are used to uniquely identify the customer. A merchant account number may be, for example, any number or alpha-numeric characters that identify a particular merchant for purposes of card acceptance, account reconciliation, reporting, or the like.

A “transaction account” (“TXA”) includes any account that may be used to facilitate a financial transaction. A “TXA issuer” includes any entity that offers TXA services to customers.

“TXA identification data” or “transaction coordination code” (each of which are referred to as “TXA-ID”) includes data used to identify, coordinate, pre-authorize and/or authorize transactions to a TXA. The TXA-ID may also provide unique identification and unique authorization. The TXA-ID may include, for example, a code, authorization/access code, a transaction account identification number, demographic data, encryption key, proxy account number, PIN, Internet code, card identification number (CID), number, letter, symbol, digital certificate, smart chip, digital signal, analog signal, RFID, biometric or other identifier/indicia suitably configured to uniquely identify authorization to charge to a TXA. A CID number is used in many credit or charge card transaction accounts. For further information regarding CIDs see, for example: Systems and Methods for Authorizing a Transaction Card, U.S. Pat. No. 6,182,894 issued on Feb. 5, 2001; and System and Method for Facilitating a Financial Transaction with a Dynamically Generated Identifier, U.S. Ser. No. 11/847,088 filed on Aug. 29, 2007, both of which are hereby incorporated by reference.

A “customer” includes any entity that has a TXA with a TXA issuer.

A “merchant” includes any entity that receives payment or other consideration. For example, a merchant may request payment for services rendered from a customer who holds an account with a TXA issuer.

A “financial processor” may include any entity which processes transactions, issues accounts, acquires financial information, settles accounts, conducts dispute resolution regarding accounts, and/or the like.

A “bill pay service” (“BPS”) includes any entity that enables payments or any other transaction from one entity to another entity.

A “user” 105 may include any individual or entity that interacts with system 101. User 101 may perform tasks such as requesting, retrieving, updating, analyzing, entering and/or modifying data. User 105 may be, for example, a customer establishing a bill paying arrangement through a bill paying service. User 105 may interface with Internet server 125 via any communication protocol, device or method discussed herein, known in the art, or later developed. In one embodiment, user 105 may interact with BPMS 115 via an Internet browser at a web client 110.

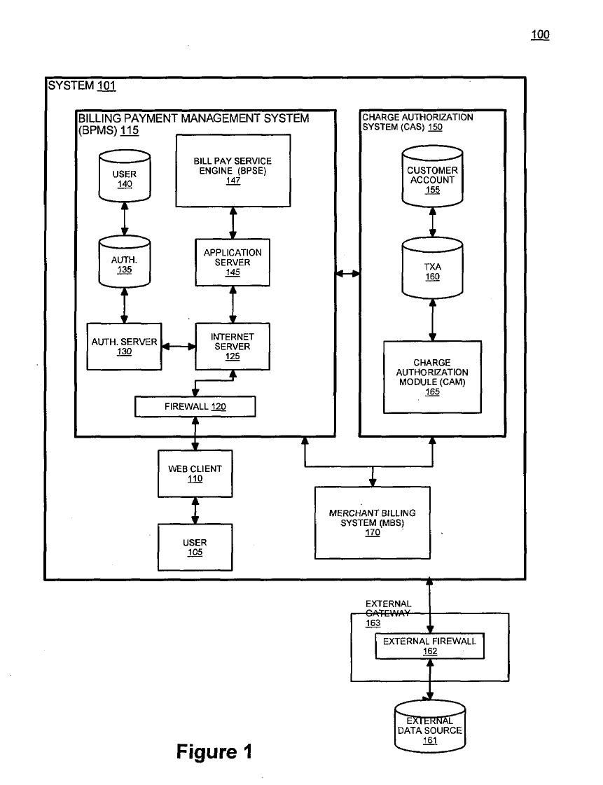

With reference to FIG. 1, the system includes a user 105 interfacing with a billing payment management system (“BPMS”) 115 by way of a web client 110. Web client 110 comprises any hardware and/or software suitably configured to facilitate requesting, retrieving, updating, analyzing, entering and/or modifying data. The data may include marketing data or any information discussed herein. Web client 110 includes any device (e.g., personal computer), which communicates (in any manner discussed herein) with the BPMS 115 via any network discussed herein. Such browser applications comprise Internet browsing software installed within a computing unit or system to conduct online transactions and communications. These computing units or systems may take the form of a computer or set of computers, although other types of computing units or systems may be used, including laptops, notebooks, hand held computers, set-top boxes, workstations, computer-servers, main frame computers, mini-computers, PC servers, pervasive computers, network sets of computers, and/or the like. Practitioners will appreciate that the web client 110 may or may not be in direct contact with the BPMS 115. For example, the web client 110 may access the services of the BPMS 115 through another server, which may have a direct or indirect connection to Internet server 125.

The invention contemplates uses in association with bill pay services, billing payment management systems, business intelligence systems, reporting systems, web services, pervasive and individualized solutions, open source, biometrics, mobility and wireless solutions, commodity computing, grid computing and/or mesh computing. For example, in an embodiment, the web client 110 is configured with a biometric security system that may be used for providing biometrics as a secondary form of identification. The biometric security system may include a transaction device and a reader communicating with the system. The biometric security system also may include a biometric sensor that detects biometric samples and a device for verifying biometric samples. The biometric security system may be configured with one or more biometric scanners, processors and/or systems. A biometric system may include one or more technologies, or any portion thereof, such as, for example, recognition of a biometric. As used herein, a biometric may include a user's voice, fingerprint, facial, ear, signature, vascular patterns, DNA sampling, hand geometry, sound, olfactory, keystroke/typing, iris, retinal or any other biometric relating to recognition based upon any body part, function, system, attribute and/or other characteristic, or any portion thereof.

The user 105 may communicate with the BPMS 115 through a firewall 120 to help ensure the integrity of the BPMS 115 components. Internet server 125 may include any hardware and/or software suitably configured to facilitate communications between the web client 110 and one or more BPMS 115 components.

Authentication server 130 may include any hardware and/or software suitably configured to receive authentication credentials, encrypt and decrypt credentials, authenticate credentials, and/or grant access rights according to pre-defined privileges attached to the credentials. Authentication server 130 may grant varying degrees of application and data level access to users based on information stored within the authentication database 135 and the user database 140.

Application server 145 may include any hardware and/or software suitably configured to serve applications and data to a connected web client 110. The bill pay service module “BPSE” 147 is configured to provide bill payment service functions. The bill payment service functions include, for example, receiving bills, alerting customers of bills and payment due dates, initiating recurring payments and/or the like. Additionally, BPSE 147 may include any hardware and/or software suitably configured to receive requests from the web client 110 via Internet server 125 and the application server 145. BPSE 147 is further configured to process requests, execute transactions, construct database queries, and/or execute queries against databases within system 101, external data sources and temporary databases, as well as exchange data with other application modules (not pictured). In one embodiment, the BPSE 147 may be configured to interact with other system 101 components to perform complex calculations, retrieve additional data, format data into reports, create XML representations of data, construct markup language documents, and/or the like. Moreover, the BPSE 147 may reside as a standalone system or may be incorporated with the application server 145 or any other BPMS 115 component as program code.

Charge authorization system (“CAS”) 150 coordinates, authorizes and executes charges to TXAs. The charge authorization module (“CAM”) 165 executes logic to processes CAS 150 functions in coordination with TXA database 160 and customer account database 155. The CAS communicates with other system 101 components such as the BPMS 115 and the merchant billing system (“MBS”) 170.

The MBS 170 is a system that coordinates billing and payments. MBS 170 may be maintained by a merchant. In one embodiment, a customer has an account with a merchant and with a TXA issuer, and the MBS 170 coordinates charges to the customer's TXA. Transactions to accounts with the TXA issuer are processed by CAS 150. The customer elects to pay debts to the merchant using a bill payment service such as BPMS 115. Thus, MBS 170, BPMS 115 and/or CAS 150 work in concert to automate billing and payment processes.

FIG. 1 depicts databases that are included in an exemplary embodiment of the invention. A representative list of various databases used herein includes: an authentication database 135, a user database 140, a customer account database 155, a TXA database 160, an external data source 161 and/or other databases that aid in the functioning of the system. As practitioners will appreciate, while depicted as a single entity for the purposes of illustration, databases residing within system 101 may represent multiple hardware, software, database, data structure and networking components. Authentication database 135 may store information used in the authentication process such as, for example, user identifiers, passwords, access privileges, user preferences, user statistics, and the like. The user database 140 maintains user information and credentials for BPMS 115 users. The customer account database stores information on customer transaction accounts such as customer demographic information, authorized merchant information, rewards program information and any other information that enables making charges to a customer transaction account. The transaction TXA database 160 stores financial transactions. As practitioners will appreciate, embodiments are not limited to the exemplary databases described above, nor do embodiments necessarily utilize each of the disclosed exemplary databases.

In addition to the components described above, the system 101, the BPMS 115, the CAS 150 and the MBS 170 may further include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases.

As will be appreciated by one of ordinary skill in the art, one or more system 101 components may be embodied as a customization of an existing system, an add-on product, upgraded software, a stand-alone system (e.g., kiosk), a distributed system, a method, a data processing system, a device for data processing, and/or a computer program product. Accordingly, individual system 101 components may take the form of an entirely software embodiment, an entirely hardware embodiment, or an embodiment combining aspects of both software and hardware. Furthermore, individual system 101 components may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

As those skilled in the art will appreciate, the web client 110 includes an operating system (e.g., Windows NT, 95/98/2000, OS2, UNIX, Linux, Solaris, MacOS, etc.) as well as various conventional support software and drivers typically associated with computers. Web client 110 may include any suitable personal computer, network computer, workstation, minicomputer, mainframe, mobile device or the like. Web client 110 can be in a home or business environment with access to a network. In an embodiment, access is through a network or the Internet through a commercially available web-browser software package. Web client 110 may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., Gilbert Held, Understanding Data Communications (1996), which is hereby incorporated by reference. It is noted that the network may be implemented as other types of networks, such as an interactive television (ITV) network.

Firewall 120, as used herein, may comprise any hardware and/or software suitably configured to protect the BPMS 115 components from users of other networks. Firewall 120 may reside in varying configurations including stateful inspection, proxy based and packet filtering, among others. Firewall 120 may be integrated as software within Internet server 125, any other system components, or may reside within another computing device or may take the form of a standalone hardware component.

Internet server 125 may be configured to transmit data to the web client 110 within markup language documents. As used herein, “data” may include encompassing information such as commands, queries, files, data for storage, and/or the like in digital or any other form. Internet server 125 may operate as a single entity in a single geographic location or as separate computing components located together or in separate geographic locations. Further, Internet server 125 may provide a suitable web site or other Internet-based graphical user interface, which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, InterBase, etc., may be used to provide an Active Data Object (ADO) compliant database management system.

Like Internet server 125, the application server 145 may communicate with any number of other servers, databases and/or components through any means known in the art. Further, the application server 145 may serve as a conduit between the web client 110 and the various systems and components of the BPMS 115. Internet server 125 may interface with the application server 145 through any means known in the art including a LAN/WAN, for example. Application server 145 may further invoke software modules such as the BPSE 147 in response to user 105 requests.

Any of the communications, inputs, storage, databases or displays discussed herein may be facilitated through a web site having web pages. The term “web page” as it is used herein is not meant to limit the type of documents and applications that may be used to interact with the user. For example, a typical web site may include, in addition to standard HTML documents, various forms, Java applets, JavaScript, active server pages (ASP), common gateway interface scripts (CGI), extensible markup language (XML), dynamic HTML, cascading style sheets (CSS), helper applications, plug-ins, and/or the like. A server may include a web service that receives a request from a web server, the request including a URL (http://yahoo.com/stockquotes/ge) and an internet protocol (“IP”) address. The web server retrieves the appropriate web pages and sends the data or applications for the web pages to the IP address. Web services are applications that are capable of interacting with other applications over a communications means, such as the Internet. Web services are typically based on standards or protocols such as XML, SOAP, WSDL and UDDI. Web services methods are well known in the art, and are covered in many standard texts. See, e.g., Alex Nghiem, IT Web Services: A Roadmap for the Enterprise (2003), hereby incorporated by reference.

Any database depicted or implied by FIG. 1 may include any hardware and/or software suitably configured to facilitate storing identification, authentication credentials, and/or user permissions. One skilled in the art will appreciate that system 101 may employ any number of databases in any number of configurations. Further, any databases discussed herein may be any type of database, such as relational, hierarchical, graphical, object-oriented, and/or other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one aspect of the invention, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In an embodiment, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the system by multiple and unrelated owners of the data sets. For example, a first data set which may be stored may be provided by a first party, a second data set which may be stored may be provided by an unrelated second party, and yet a third data set which may be stored, may be provided by a third party unrelated to the first and second parties. Each of the three data sets in this example may contain different information that is stored using different data storage formats and/or techniques. Further, each data set may contain subsets of data that also may be distinct from other subsets.

As stated above, in various embodiments of system 101, the data can be stored without regard to a common format. However, in one embodiment of the invention, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a stand-alone interaction device configured to add, delete, modify, or augment the data in accordance with the header or trailer. As such, in one embodiment, the header or trailer is not stored on the transaction device along with the associated issuer-owned data but instead the appropriate action may be taken by providing to the transaction instrument user at the stand-alone device, the appropriate option for the action to be taken. System 101 contemplates a data storage arrangement wherein the header or trailer, or header or trailer history, of the data is stored on the transaction instrument in relation to the appropriate data.

One skilled in the art will also appreciate that, for security reasons, any databases, systems, devices, servers or other components of system 101 may consist of any combination thereof at a single location or at multiple locations, wherein each database or system includes any of various suitable security features, such as firewalls, access codes, encryption, decryption, compression, decompression, and/or the like.

The system 101 may be interconnected to an external data source 161 (for example, to obtain data from a vendor) via a second network, referred to as the external gateway 163. The external gateway 163 may include any hardware and/or software suitably configured to facilitate communications and/or process transactions between the system 101 and the external data source 161. Interconnection gateways are commercially available and known in the art. External gateway 163 may be implemented through commercially available hardware and/or software, through custom hardware and/or software components, or through a combination thereof. External gateway 163 may reside in a variety of configurations and may exist as a standalone system or may be a software component residing either inside EDMS 150, the external data source 161 or any other known configuration. External gateway 163 may be configured to deliver data directly to system 101 components (such as BPSE 147) and to interact with other systems and components such as EDMS 150 databases. In one embodiment, the external gateway 163 may comprise web services that are invoked to exchange data between the various disclosed systems. The external gateway 163 represents existing proprietary networks that presently accommodate data exchange for data such as financial transactions, customer demographics, billing transactions and the like. The external gateway 163 is a closed network that is assumed to be secure from eavesdroppers.

The invention may be described herein in terms of functional block components, screen shots, optional selections and various processing steps. It should be appreciated that such functional blocks may be realized by any number of hardware and/or software components configured to perform the specified functions. For example, system 101 may employ various integrated circuit components, e.g., memory elements, processing elements, logic elements, look-up tables, and/or the like, which may carry out a variety of functions under the control of one or more microprocessors or other control devices. Similarly, the software elements of system 101 may be implemented with any programming or scripting language such as C, C++, Java, COBOL, assembler, PERL, Visual Basic, SQL Stored Procedures, extensible markup language (XML), cascading style sheets (CSS), extensible style sheet language (XSL), with the various algorithms being implemented with any combination of data structures, objects, processes, routines or other programming elements. Further, it should be noted that system 101 may employ any number of conventional techniques for data transmission, signaling, data processing, network control, and/or the like. Still further, system 101 could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

These software elements may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, web sites, web forms, prompts, etc. Practitioners will appreciate that the illustrated steps described herein may comprise in any number of configurations including the use of windows, web pages, web forms, popup windows, prompts and/or the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

Practitioners will appreciate that there are a number of methods for displaying data within a browser-based document. Data may be represented as standard text or within a fixed list, scrollable list, drop-down list, editable text field, fixed text field, pop-up window, and/or the like. Likewise, there are a number of methods available for modifying data in a web page such as, for example, free text entry using a keyboard, selection of menu items, check boxes, option boxes, and/or the like.

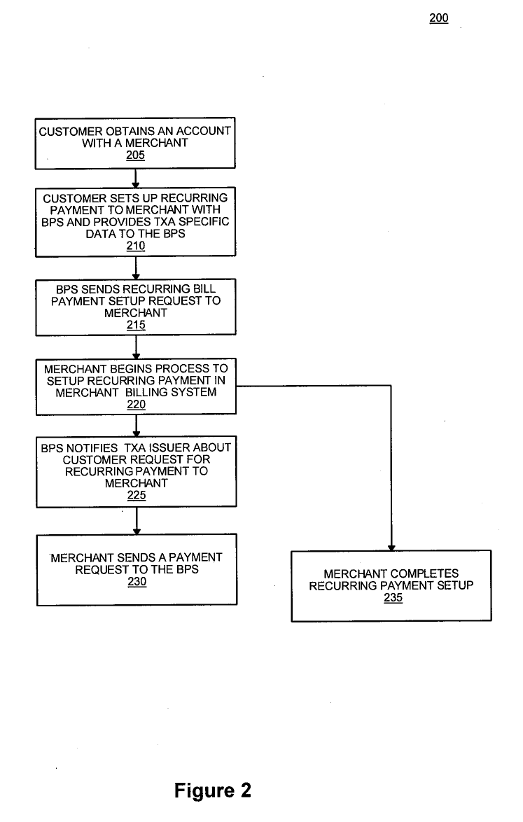

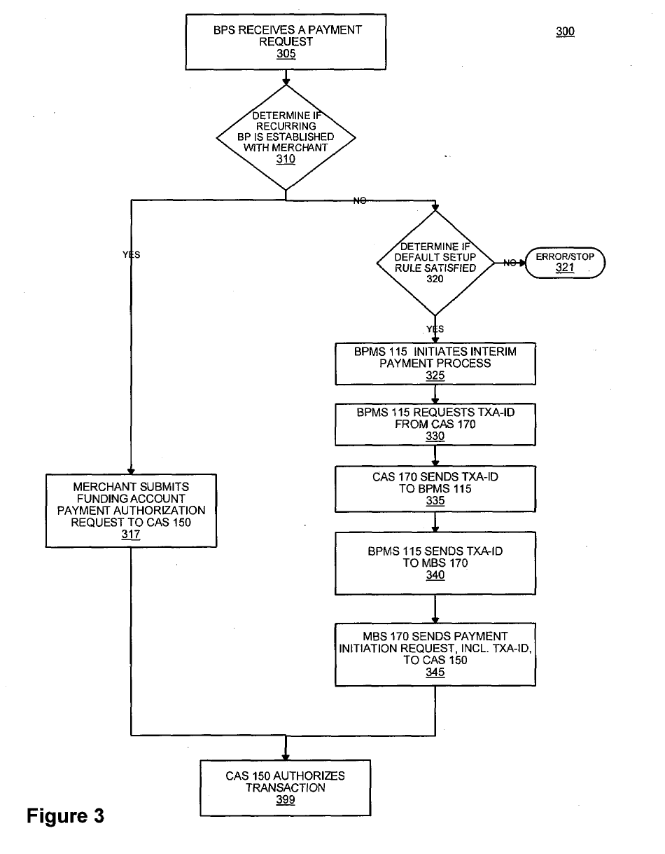

Referring now to the figures, the block system diagrams and process flow diagrams represent mere embodiments of the invention and are not intended to limit the scope of the invention as described herein. For example, the steps recited in FIGS. 2-3 may be executed in any order and are not limited to the order presented. It will be appreciated that the following description makes appropriate references not only to the steps depicted in FIGS. 2-3, but also to the various system components as described above with reference to FIG. 1.

With reference to FIG. 1, in one embodiment, when user 105 logs on to an application, Internet server 125 may invoke an application server 145. Application server 145 invokes logic in the BPSE 147 by passing parameters relating to the user's 105 requests for data. The BPMS 115 manages requests for data from the BPSE 147 and communicates with system 101 components. Transmissions between the user 105 and the Internet server 125 may pass through a firewall 120 to help ensure the integrity of the BPMS 115 components. Practitioners will appreciate that the invention may incorporate any number of security schemes or none at all. In one embodiment, the Internet server 125 receives page requests from the web client 110 and interacts with various other system 101 components to perform tasks related to requests from the web client 110. Internet server 125 may invoke an authentication server 130 to verify the identity of user 105 and assign specific access rights to user 105. In order to control access to the application server 145 or any other component of the BPMS 115, Internet server 125 may invoke an authentication server 130 in response to user 105 submissions of authentication credentials received at Internet server 125. When a request to access system 101 is received from Internet server 125, Internet server 125 determines if authentication is required and transmits a prompt to the web client 110. User 105 enters authentication data at the web client 110, which transmits the authentication data to Internet server 125. Internet server 125 passes the authentication data to authentication server which queries the user database 140 for corresponding credentials. When user 105 is authenticated, user 105 may access various applications and their corresponding data sources.

Referring now to FIG. 2, a representative process for establishing a BPS to pay bills to a merchant using a TXA is shown. A customer wishes to establish a recurring payment from a TXA to a merchant. In one embodiment, the customer establishes an account with a merchant (Step 205). The customer (depicted as user 105 in FIG. 1) sets up the merchant in the BPMS 115 so that automatic and recurring payments can be made by the BPS from the customer's TXA (Step 210). In one embodiment, a BPS employee or representative configures BPMS 115 according to customer instructions (e.g. the customer gives the BPS representative information over the telephone).

In one embodiment, the customer may be a consumer of the merchant, the TXA issuer and the BPS. In one embodiment, the TXA issuer contracts directly with the BPS such that, from the customer's perspective, the bill pay functionality and the TXA service is provided by the same entity. In one embodiment, the BPS and the TXA issuer are the same entity. BPMS 115, as depicted in FIG. 1, is the system used by the BPS to provide bill payment functionality. In one embodiment, the customer account is a TXA that uses a TXA-ID (such as a CID) to validate transaction requests. The customer provides TXA specific data, but typically does not provide the TXA-ID when setting up a merchant with the BPMS 115 (Step 210). The BPMS 115 sends information to the merchant to establish that the BPS will act as liaison between the merchant and the customer for future interactions (e.g. when the merchant requests payment from the customer). In one embodiment, the BPMS 115 sends a request to establish automatic or recurring bill payments (partial or full payments) with the merchant so that the merchant is able to charge the TXA directly (Step 215). In one embodiment, multiple interim payments are processed. For example, a customer may purchase goods or services on a trial basis and the payments during the trial are enabled using the interim payment method. When the trial period ends, payments are processed using the recurring payment method. Referring back to the representative embodiment shown in FIG. 2, the merchant begins to configure their internal systems (such as the MBS 170 shown in FIG. 1), to interface with the BPMS 115 (Step 220). BPMS 115 notifies CAS 150 of the customer request for automatic or recurring payments from the customer's TXA to the merchant (Step 225). The merchant sends a request for payment to the BPS (Step 230). Completing the setup of the recurring payment in the billing system (Step 235) may occur before or after the merchant requests a payment.

FIG. 3 is a representative process flow diagram for processing payment requests by a merchant using a bill paying service. The BPMS 115 service receives a notification that a payment is due to the merchant (Step 305). As practitioners will appreciate, various techniques exist for receiving information from another system. For instance, in one embodiment, BPMS 115 uses screen scraping methods to receive payment request data from the merchant. In one embodiment, the merchant sends BPMS 115 a customer's billing and/or invoice information. The set-up time to configure the automatic or recurring payments in the MBS 170 may prevent the customer's automatic payment instructions from being established in MBS 170 before the first payment is due. Thus, BPMS 115 determines if the MBS 170 is configured to perform the recurring billing process (Step 310). In one embodiment, BPMS 115 makes this determination by querying CAS 150.

In the representative embodiment illustrated in FIG. 3, if automatic bill payment is already enabled the merchant submits a payment authorization request to CAS 150 (Step 317). In one embodiment, if automatic bill payment is already enabled, the BPMS 115 initiates a recurring or automatic payment process with the merchant and the merchant submits a payment authorization request to CAS 150. The payment is authorized (Step 399).

If recurring or automatic bill payment is not already established in the MBS 170 for the customer (Step 310), the BPMS 115 executes a default rule to determine whether to continue with an interim payment process (Step 320). In one embodiment, the default rule is a determination of whether a specified period of time has elapsed since MBS 170 received the request to configure recurring or automatic payments for this customer. If the elapsed time is greater than the specified time, the request is denied, an error or exception is generated and the process ends (Step 321). In one embodiment, the default rule is determined by factors such as business rules specific to the merchant, the TXA issuer a customer specified rule or any of these factors combined with elapsed time.

If the default rule (Step 320) is satisfied, an “interim” payment process is initiated (Step 325). The interim payment process allows the merchant to receive partial or full payment in the period after the customer has requested automatic or recurring billing but before the recurring billing is fully enabled by the MBS 170 and/or the CAS 150. Often, the merchant is not authorized to persistently store the TXA-ID. The BPMS 115 requests the TXA-ID from the CAS 150 (Step 330) and the CAS 150 sends BPMS 115 the TXA-ID (Step 335). In one embodiment, BPMS 115 receives the TXA-ID indirectly via a web based service. In one embodiment, the CAS 150 sends a security mask proxy identifier in place of the TXA-ID and the proxy identifier has a limited to charge against a TXA. As practitioners will appreciate, the methods for limiting the proxy identifier are numerous including limiting as a function of time, TXA, merchant, bill pay service provider and/or a combination of any or all of these. BPMS 115 sends MBS 170 the TXA-ID (Step 340). MBS 170 submits the payment request and the TXA-ID to the CAS 150 (Step 345). CAS 150 authorizes the payment transaction against the customer's TXA (Step 399).

For further information regarding security mask proxy identifiers see, for example, System And Method For Securing Sensitive Information During Completion Of A Transaction, U.S. Ser. No. 10/708,569, filed on Mar. 11, 2004 and System And Method For Re-Associating An Account Number To Another Transaction Account, U.S. Ser. No. 10/710,484, filed on Jul. 14, 2004, both of which are hereby incorporated by reference.

In existing systems, manual intervention by the customer is often requested because both the merchant and the bill pay service may not have access to the additional information required as part of the authorization request to charge the transaction account. Certain types of information provided by the customer as part of initializing a payment, or setting up recurring payments, are often not permitted, for example, by law, privacy policy, contract or other restriction to be stored by merchants. Thus, the present invention greatly increases customer satisfaction, process efficiency, and transaction security by providing an automated mechanism for authorizing an interim payment.

While the steps outlined above represent a specific embodiment of the invention, practitioners will appreciate that there are any number of computing algorithms and user interfaces that may be applied to create similar results. The steps are presented for the sake of explanation only and are not intended to limit the scope of the invention in any way.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims of the invention. It should be understood that the detailed description and specific examples, indicating exemplary embodiments of the invention, are given for purposes of illustration only and not as limitations. Many changes and modifications within the scope of the instant invention may be made without departing from the spirit thereof, and the invention includes all such modifications. Corresponding structures, materials, acts, and equivalents of all elements in the claims below are intended to include any structure, material, or acts for performing the functions in combination with other claim elements as specifically claimed. The scope of the invention should be determined by the appended claims and their legal equivalents, rather than by the examples given above. Reference to an element in the singular is not intended to mean “one and only one” unless explicitly so stated, but rather “one or more.” Moreover, where a phrase similar to ‘at least one of A, B, and C’ is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

We claim:

1. A method for interim authorization comprising:
receiving a request from a merchant to authorize an interim payment to the merchant, prior to enablement of a recurring payment process from the financial processor to the merchant;
requesting a transaction coordination code from a financial processor;
receiving the transaction coordination code; and,
sending the transaction coordination code to the merchant, wherein the merchant obtains the interim payment from the financial processor using the transaction coordination code.

2. The method of claim 1, wherein the transaction coordination code includes a card identification number (CID).

3. The method of claim 1, wherein the transaction coordination code includes at least one of: card code, authorization/access code, demographic data, encryption key, proxy account number, PIN, Internet code, card identification number (CID), number, letter, symbol, digital certificate, smart chip, digital signal, analog signal, RFID, biometric or other identifier/indicia suitably configured to uniquely identify authorization to charge to an account.

4. The method of claim 1, further comprising determining whether the recurring payment has been executed.

5. The method of claim 1, further comprising determining whether the request complies with a predetermined rule.

6. The method of claim 1, further comprising determining whether the request complies with a predetermined rule which includes a predetermined timeframe.

7. The method of claim 1, further comprising:
receiving a request to establish a recurring payment to the merchant;
notifying the merchant of the recurring payment, wherein the merchant configures a merchant system to process the recurring payment, and wherein the recurring payment will not be executed until the processing occurs; and,
notifying the financial processor of the recurring payment, wherein the financial processor configures an authorization system to process the recurring payment.

8. A method for requesting an interim payment comprising:
sending a request to authorize a payment to the merchant, prior to enablement of a recurring payment process from the financial processor to the merchant;
receiving a transaction coordination code from a bill pay service, wherein the bill pay service receives the transaction coordination code from a financial processor; and,
requesting the interim payment, wherein the payment request includes the transaction coordination code.

9. A method for processing an interim payment:
receiving a request for a transaction coordination code from a bill pay service, wherein the bill pay service receives a request for a interim payment to a merchant, and wherein the request for the interim payment is prior to enablement of a recurring payment from a financial processor to the merchant;
sending the transaction coordination code to the bill pay service, wherein the merchant obtains the interim payment from the financial processor using the transaction coordination code;
receiving a request from the merchant for the interim payment wherein the request includes the transaction coordination code.

10. A machine-readable medium having stored thereon a plurality of instructions for interim authorization, said plurality of instructions when executed by at least one processor, cause said processor to perform a method comprising the steps of:
receiving a request from a merchant to authorize an interim payment to the merchant, prior to enablement of a recurring payment from the financial processor to the merchant;
requesting a transaction coordination code from a financial processor;
receiving the transaction coordination code; and,
sending the transaction coordination code to the merchant, wherein the merchant obtains the interim payment from the financial processor using the transaction coordination code.

11. A bill payment management system comprising:
a bill payment engine configured to:
receive a request from a merchant to authorize an interim payment to the merchant, prior to enablement of a recurring payment from the financial processor to the merchant;
request a transaction coordination code from a financial processor;
receive the transaction coordination code; and,
send the transaction coordination code to the merchant, wherein the merchant obtains the interim payment from the financial processor using the transaction coordination code.
a bill payment tracking engine configured to track a plurality of bills through a bill payment cycle and to generate messages to at least one of: the merchant, the financial processor and a customer.
